(19) United States
(12) Patent Application Publication
(10) Pub. No.: US 2026/0104384 A1
(43) Pub. Date: Apr. 16, 2026

(54) HYDROGEN SULFIDE DETECTION DEVICE

(71) Applicant: TOYOTA JIDOSHA KABUSHIKI KAISHA, Toyota-shi (JP)

(72) Inventor: Yuki NONAKA, Toyota-shi (JP)

(73) Assignee: TOYOTA JIDOSHA KABUSHIKI KAISHA, Toyota-shi (JP)

(21) Appl. No.: 19/338,342

(22) Filed: Sep. 24, 2025

(30) Foreign Application Priority Data
Oct. 16, 2024 (JP) 2024-180615

(51) Int. Cl. G01N 27/416; H01M 10/48

(52) U.S. Cl. CPC G01N 27/4162; H01M 10/48

(57) ABSTRACT

A hydrogen sulfide detection device includes a wire that electrically connects a first node and a second node, and a monitoring circuit that monitors a voltage between the first node and the second node. The wire includes a pattern that is provided on a substrate and is made of a metal that reacts with hydrogen sulfide to corrode, and the pattern includes at least one via. A recessed portion is present in a surface of the substrate, and each of the at least one via is exposed to outside of the substrate through the recessed portion.

### CROSS-REFERENCE TO RELATED APPLICATION

This application claims priority to Japanese Patent Application No. 2024-180615 filed on Oct. 16, 2024. The disclosure of the above-identified application, including the specification, drawings, and claims, is incorporated by reference herein in its entirety.

### BACKGROUND

### 1. Technical Field

The present disclosure relates to a hydrogen sulfide detection device to be applied to a battery pack that stores a battery cell including a sulfide-based electrolyte.

### 2. Description of Related Art

An all solid state battery is attracting attention as a next-generation battery cell constituting a battery pack. The all solid state battery has advantages of high safety and long lifetime as compared with conventional batteries using liquid as an electrolyte. In particular, an all solid state battery using a sulfide-based electrolyte has a large capacity and high output, and is expected to be used as a battery for a vehicle.

Meanwhile, when the battery cell including the sulfide-based electrolyte is configured as the battery cell of the all solid state battery, a failure may cause generation of a hydrogen sulfide gas. The hydrogen sulfide gas is toxic, and corrodes metal components provided around. Accordingly, there is a demand for a technology for appropriately detecting generation of hydrogen sulfide in the battery pack that stores the battery cell including the sulfide-based electrolyte.

Japanese Unexamined Patent Application Publication No. 2002-251985 (JP 2002-251985 A) discloses a technology in which a substrate including a first copper foil ribbon and a second copper foil ribbon is provided in a battery pack, and an electrolyte solution leaking from the battery is detected from a duration time of voltage drop of a voltage between the first copper foil ribbon and the second copper foil ribbon or the number of times of the voltage drop. Besides, Japanese Unexamined Patent Application Publication No. 2003-035705 (JP 2003-035705 A) and WO 03/029801 are provided as documents representing the technical level of the technical field.

### SUMMARY

When hydrogen sulfide is generated from the battery cell, it is desirable to detect the generation of the hydrogen sulfide reliably and as fast as possible. In the technology disclosed in JP 2002-251985 A, when the amount of generated hydrogen sulfide is minute or the like, the reaction with each copper foil ribbon may not sufficiently progress, and generation of the hydrogen sulfide may be undetectable. As described above, it is desired to improve the detection accuracy of the generation of the hydrogen sulfide.

The present disclosure has been made in view of the above-mentioned problems. The present disclosure has one object to provide a technology capable of detecting generation of hydrogen sulfide with high accuracy.

One aspect of the present disclosure relates to a hydrogen sulfide detection device to be applied to a battery pack that stores a battery cell including a sulfide-based electrolyte. The hydrogen sulfide detection device includes a wire that electrically connects a first node and a second node, and a monitoring circuit that monitors a voltage between the first node and the second node. The wire includes a pattern that is provided on a substrate and is made of a metal that reacts with hydrogen sulfide to corrode, and the pattern includes at least one via. A recessed portion is present in a surface of the substrate, and each of the at least one via is exposed to outside of the substrate through the recessed portion.

With the present disclosure, the hydrogen sulfide gas passes through the recessed portion to flow into the via to cause the metal of the via to corrode. Thus, the generation of the hydrogen sulfide is detected. The hydrogen sulfide that has flowed in is brought to a state of staying inside of the via, and hence the corrosion of the metal of the via progresses quickly even when only a minute amount of hydrogen sulfide flows in. Accordingly, the generation of the hydrogen sulfide can be detected with high accuracy.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a hydrogen sulfide detection device according to a first embodiment;

FIG. 2 is a sectional view illustrating a configuration of a sensing section;

FIG. 3 is an explanatory schematic diagram illustrating an operation of the hydrogen sulfide detection device;

FIG. 4 is a flowchart illustrating a processing flow of processing executed by a monitoring circuit;

FIG. 5 is a schematic view illustrating examples of disposition of vias in the sensing section; and

FIG. 6 is a schematic view illustrating an example of disposition of a substrate.

### DETAILED DESCRIPTION OF EMBODIMENTS

Hereinafter, an embodiment of the present disclosure is described with reference to the accompanying drawings. It is to be noted that the same or corresponding configurations in each figure are denoted by the same reference symbols, and description thereof is simplified or omitted.

### 1 Hydrogen Sulfide Detection Device

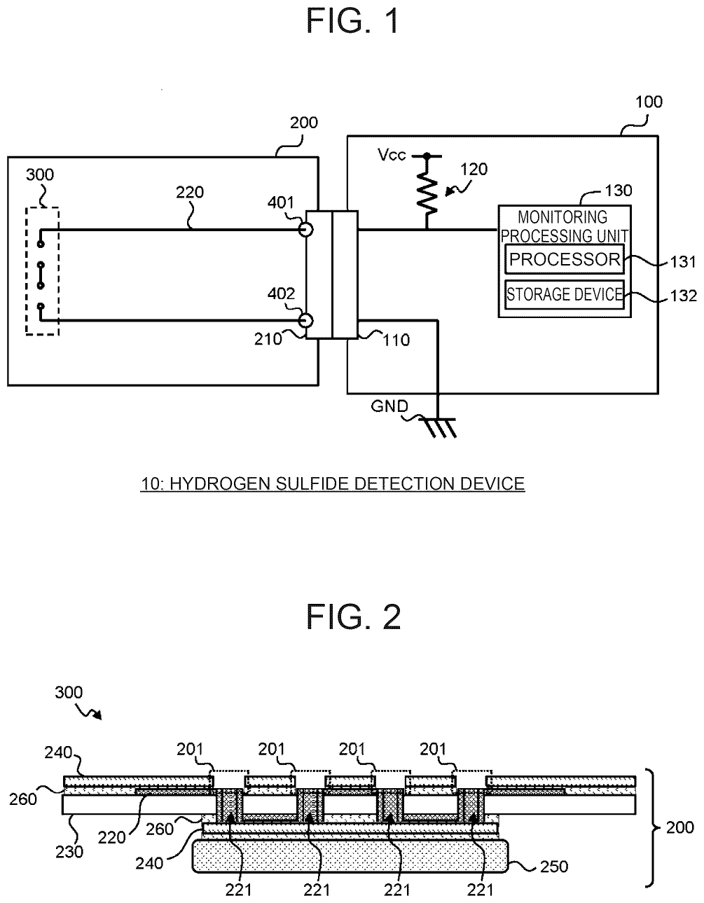

FIG. 1 is a schematic diagram illustrating a configuration of a hydrogen sulfide detection device 10 according to the present embodiment. The hydrogen sulfide detection device 10 is applied to a battery pack that stores a battery cell including a sulfide electrolyte, and detects generation of hydrogen sulfide. The hydrogen sulfide detection device 10 may be stored in the battery pack together with the battery cell. The battery cell including the sulfide electrolyte is typically an all solid state battery using a solid sulfide electrolyte. The mode of the battery cell is not particularly limited. For example, the mode of the battery cell may be a laminated type or a prismatic type. The all solid state battery using the sulfide electrolyte has a large capacity and high output, and is suitable for a battery of a vehicle. Thus, the battery pack to which the hydrogen sulfide detection device 10 is applied may particularly be a battery to be mounted on a vehicle.

The hydrogen sulfide detection device 10 includes a monitoring circuit 100 and a substrate 200. The substrate 200 is a printed circuit board (PCB) including a pattern 220 formed of a metal. The substrate 200 may particularly be a flexible printed circuit (FPC) board. The pattern 220 of the substrate 200 forms a wire that electrically connects a first node 401 and a second node 402 (hereinafter simply referred to as “wire”).

The monitoring circuit 100 and the substrate 200 are connected to external devices via respective connectors 110, 210. In the hydrogen sulfide detection device 10 illustrated in FIG. 1, the monitoring circuit 100 and the substrate 200 are directly connected to each other by the connectors 110, 210.

The monitoring circuit 100 monitors a voltage between the first node 401 and the second node 402. In the monitoring circuit 100, the first node 401 is connected to a power supply of a voltage Vcc (for example, 5 V) via a resistor 120, and the second node 402 is connected to a ground GND having a reference potential (for example, 0 V). The monitoring circuit 100 includes a monitoring processing unit 130. The monitoring processing unit 130 is a computer that executes processing of monitoring the voltage. The monitoring processing unit 130 may be implemented by a microcontroller. The monitoring processing unit 130 is disposed to receive a potential between the resistor 120 and the first node 401 as input. For example, when the monitoring processing unit 130 is a microcontroller, an input port of the microcontroller is connected between the resistor 120 and the first node 401. The resistor 120 is a pull-up resistor for the monitoring processing unit 130. For example, the resistance value of the resistor 120 is about 10 kΩ. The monitoring circuit 100 constitutes a voltage-dividing circuit, and the monitoring processing unit 130 can detect the voltage between the first node 401 and the second node 402.

It is to be noted that the configuration of the monitoring circuit 100 illustrated in FIG. 1 is merely an example, and the monitoring circuit 100 can adopt other configurations. For example, the voltage between the first node 401 and the second node 402 can be indirectly detected even by measuring a voltage across both ends of the resistor 120. That is, monitoring the voltage between the first node 401 and the second node 402 includes monitoring the voltage across both ends of the resistor 120. Thus, the monitoring processing unit 130 may be disposed to measure the voltage across both ends of the resistor 120. Further, for example, the monitoring circuit 100 can be configured such that the resistor 120 becomes a pull-down resistor for the monitoring processing unit 130. That is, the first node 401 may be directly connected to the power supply, and the second node 402 may be connected to the ground GND via a resistor. Further, the monitoring processing unit 130 may be disposed to detect the voltage between the first node 401 and the second node 402. For example, the input port of the microcontroller is connected between the resistor and the second node 402.

The monitoring processing unit 130 includes one or more processors 131 (hereinafter simply referred to as “processor 131”) and one or more storage devices 132 (hereinafter simply referred to as “storage device 132”). The processor 131 executes various types of processing. Examples of the processor 131 include a general-purpose processor, a specific-use processor, a central processing unit (CPU), a graphics processing unit (GPU), an application specific integrated circuit (ASIC), a field-programmable gate array (FPGA), an integrated circuit, a conventional circuit, and a combination of one or more of those circuits. The processor 131 can also be called a processing circuitry. The storage device 132 stores various types of information required for execution of processing by the processor 131. Examples of the storage device 132 include recording media such as a random access memory (RAM), a read only memory (ROM), a solid state drive (SSD), and a hard disk drive (HDD). The storage device 132 stores a computer program that can be executed by the processor 131. The computer program is configured of a plurality of instruction codes writing the processing to be executed by the processor 131. The computer program is recorded in a computer-readable recording medium. The functions of the monitoring processing unit 130 are implemented through cooperation between the storage device 132 and the processor 131 that executes the computer program.

As a metal forming the pattern 220 of the substrate 200, a metal that reacts with hydrogen sulfide to corrode is used. For example, copper or silver is used as the metal. Moreover, the substrate 200 includes a sensing section 300 that senses hydrogen sulfide. Hereinafter, with reference to FIG. 2, the configuration of the sensing section 300 is described.

FIG. 2 is a sectional view illustrating a cross section of the sensing section 300 of the substrate 200. In the sensing section 300, the substrate 200 has a two-layer configuration in which the pattern 220 is formed on both surfaces of a base material 230. When the substrate 200 is configured as the FPC, polyimide or liquid crystal polymer is used as the base material 230. However, the substrate 200 may be configured as a rigid substrate. In this case, paper phenol, paper epoxy, glass epoxy, or the like is used as the base material 230.

In the sensing section 300, the pattern 220 includes at least one via 221, and forms one current path that crosses a layer through the via 221. In the example illustrated in FIG. 2, the pattern 220 includes four vias 221, and forms a current path that crosses the layer four times through the vias 221. Each of the vias 221 is hollow, and has an inner wall surface plated with the same metal as the pattern 220.

Both surfaces of the substrate 200 are coated with a surface protecting material 240 (for example, coverlay or solder resist) with the use of an adhesive 260. However, as illustrated in FIG. 2, a recessed portion 201 is present in one surface of the substrate 200 as a part not coated with the surface protecting material 240. In addition, each of the vias 221 of the pattern 220 is exposed to the outside of the substrate 200 through the recessed portion 201. In other words, one surface of the substrate 200 is coated with the surface protecting material 240 such that the position of each of the vias 221 of the pattern 220 matches the recessed portion 201. In the following, the surface of the substrate 200 on the side on which the recessed portion 201 is present is referred to as “first surface”, and the surface on the side opposite to the first surface is referred to as “second surface”. In particular, in the hydrogen sulfide detection device 10, the substrate 200 is disposed such that the first surface faces vertically upward. That is, the recessed portion 201 opens vertically upward.

In the sensing section 300, a reinforcing plate 250 is further attached to the second surface of the substrate 200 in a part in which the pattern 220 is formed, with the use of the adhesive 260. The via 221 of the pattern 220 is easily disconnected by a physical external force. Thus, the reinforcing plate 250 can improve the resistance of the sensing section 300 against vibration and impact.

The sensing section 300 of the substrate 200 is configured as described above. As described above, the pattern 220 of the sensing section 300 provides one current path that crosses a layer through the vias 221. Accordingly, the wire that connects the first node 401 and the second node also provides one current path. Further, in the example illustrated in FIG. 2, the substrate 200 partially has a two-layer configuration in the sensing section 300. However, the substrate 200 may be configured to have a two-layer configuration as a whole. Alternatively, the substrate 200 may be configured to have a multilayer configuration including three layers or more. In any case, the substrate 200 may have a first surface in which the recessed portion 201 is present, and each via 221 of the pattern 220 may be configured to be exposed to the outside of the substrate 200 through the recessed portion 201.

The hydrogen sulfide detection device 10 according to the present embodiment is configured as described above. Hereinafter, the operation of the hydrogen sulfide detection device 10 is described in detail.

### 2 Operation of Hydrogen Sulfide Detection Device

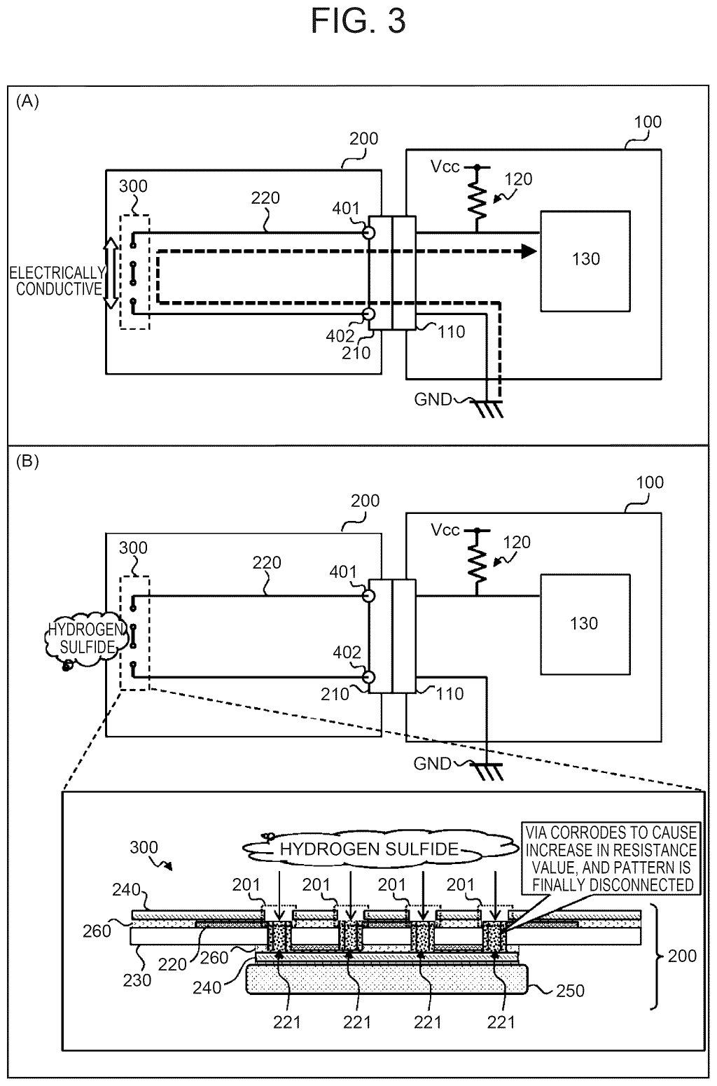

FIG. 3 is an explanatory schematic diagram illustrating the operation of the hydrogen sulfide detection device 10. Part (A) in FIG. 2 illustrates an operation when the target battery pack is normal. That is, an operation when no hydrogen sulfide is generated from the battery cell is illustrated. In a normal state, the pattern 220 of the sensing section 300 is in an electrically conductive state, and the wire is simply a current path including no resistor. Thus, the monitoring processing unit 130 acquires the reference potential of the ground GND as the detection value.

Part (B) in FIG. 2 illustrates an operation in an abnormal state, that is, an operation when hydrogen sulfide is generated from the battery cell. At this time, the hydrogen sulfide gas passes through the recessed portion 201 to flow into the via 221. In this case, the metal of the via 221 reacts with the hydrogen sulfide that has flowed in to corrode. When the metal becomes a sulfide by corrosion, the resistance value of the sensing section 300 increases. Moreover, the metal tends to move radially by corrosion. Further, the corroded metal moves also when vibrations are applied thereto. For example, when vibrations of the vehicle are transmitted, the corroded metal moves. As the corrosion progresses as described above, the metal of the via 221 gradually disappears. In this manner, the resistance value of the sensing section 300 further increases. Then, the pattern 220 of the sensing section 300 is finally disconnected. In addition, according to the present embodiment, the recessed portion 201 opens vertically upward, and hydrogen sulfide is heavier than air. Thus, the hydrogen sulfide that has flowed in is brought to a state of staying inside of the via 221. Accordingly, the corrosion of the metal of the via 221 can quickly progress.

In a process in which the resistance value of the sensing section 300 increases, the monitoring processing unit 130 acquires a divided voltage caused by the resistance value of the sensing section 300 as the detection value. That is, as the resistance value of the sensing section 300 increases, the detection value of the monitoring processing unit 130 increases from the reference potential. Then, when the pattern 220 of the sensing section 300 is finally disconnected, the voltage Vcc of the power supply is directly input to the monitoring processing unit 130. That is, the monitoring processing unit 130 acquires the voltage Vcc of the power supply as the detection value.

As described above, when the hydrogen sulfide is generated from the battery cell, the sensing state of the sensing section 300 appears as a voltage between the first node 401 and the second node 402. That is, when the hydrogen sulfide is generated from the battery cell, the detection value of the monitoring processing unit 130 changes from the reference potential to Vcc. Thus, the monitoring processing unit 130 can determine whether or not the hydrogen sulfide is generated from the battery cell based on the change in detection value (the change in voltage between the first node 401 and the second node 402). For example, the monitoring processing unit 130 determines that the hydrogen sulfide is generated from the battery cell in response to the fact that a variation amount from an initial value of the detection value has become larger than a threshold value. As another example, the monitoring processing unit 130 may determine that the hydrogen sulfide is generated from the battery cell without calculating the variation amount of the detection value but directly using the detection value, in response to the fact that the detection value has become larger than a threshold value.

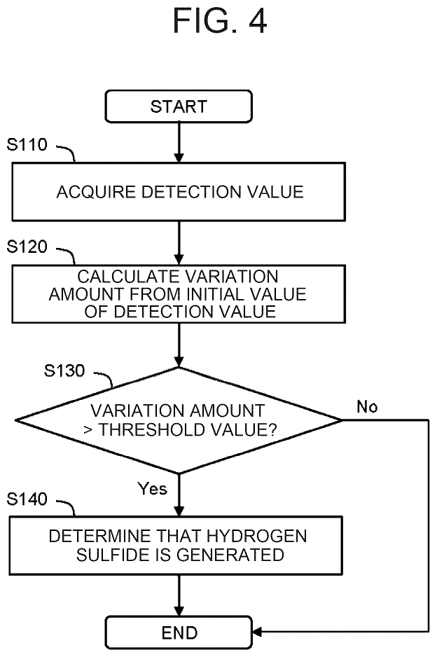

FIG. 4 is a flowchart illustrating a processing flow of processing executed by the monitoring circuit 100 (in more detail, the monitoring processing unit 130). The processing flow illustrated in FIG. 4 is repeatedly executed for each predetermined processing period.

First, in step S110, the monitoring circuit 100 acquires the detection value. Next, in step S120, the monitoring circuit 100 calculates the variation amount from the initial value of the detection value. In the monitoring circuit 100 described above, the initial value of the detection value is the reference potential, and the variation amount from the initial value is a difference between the detection value and the reference potential. In particular, when the reference potential is 0 V, the variation amount from the initial value coincides with the detection value. Next, in step S130, the monitoring circuit 100 determines whether or not the calculated variation amount is larger than a threshold value.

When the variation amount is equal to or smaller than the threshold value (step S130; No), the monitoring circuit 100 determines that no hydrogen sulfide is generated, and ends the processing of this time. When the variation amount is larger than the threshold value (step S130; Yes), the monitoring circuit 100 determines that hydrogen sulfide is generated from the battery cell (step S140). The monitoring circuit 100 may further execute processing of warning the user (for example, a driver of the vehicle) about the generation of the hydrogen sulfide by display or sound.

It is to be noted that, in the present embodiment, a magnetic noise may be superimposed on the pattern of the sensing section 300. Accordingly, in the threshold value, it is desirable to reflect a detection error caused by the magnetic noise. Further, the processing flow illustrated in FIG. 4 is merely an example, and the monitoring circuit 100 can determine that the hydrogen sulfide is generated from the battery cell by other processing flows. For example, as described above, the monitoring circuit 100 may be configured to determine that the hydrogen sulfide is generated from the battery cell without calculating the variation amount of the detection value but directly using the detection value. In this case, in the processing flow illustrated in FIG. 4, the process in step S120 is skipped. Further, in step S130, it is determined whether or not the detection value is larger than a threshold value. Then, when the detection value is larger than the threshold value, the monitoring circuit 100 may determine that hydrogen sulfide is generated from the battery cell.

### 3 Disposition of Vias in Sensing Section

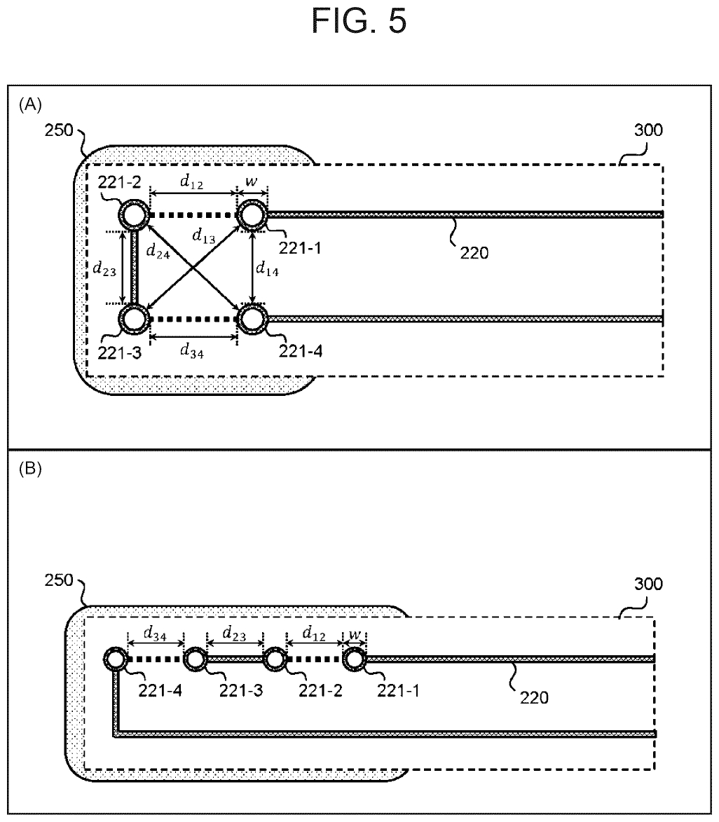

In the sensing section 300, the detection accuracy can be improved by increasing the number of vias 221 of the pattern 220. However, it is to be noted that increasing the number of vias 221 may cause reduction in resistance against vibration and impact, increase in cost, or the like. When the pattern 220 in the sensing section 300 includes two or more vias 221, it is possible to consider various patterns for the disposition of the vias 221. FIG. 5 is a schematic view illustrating examples of the disposition of the vias 221 when the pattern 220 in the sensing section 300 includes four vias 221.

### 3.1 First Example

Part (A) in FIG. 5 is a schematic view illustrating a first example of the disposition of the vias 221. Part (A) in FIG. 5 is a top view of the sensing section 300 as viewed from the first surface side. In Part (A) in FIG. 5, the broken line indicates the pattern 220 that crosses the layer to reach the second surface through the via 221. In the first example, four vias 221 (221-1, 221-2, 221-3, 221-4) are disposed in a grid pattern. In particular, the four vias 221 are disposed so that a creepage distance between two vias 221 out of the four vias 221 is larger than a diameter w of each via 221. For example, a creepage distance d₁₄ between the via 221-1 and the via 221-4 is larger than w. Similarly, creepage distances d₁₂, d₂₃, d₃₄, d₁₃, d₂₄ are each larger than w.

When the metal of the via 221 corrodes, a sulfide caused by the corrosion moves to seep out to the first surface. The sulfide has electrical conductivity, and hence, when the two vias 221 are connected by the seeping sulfide, the two vias 221 may be short circuited. In this case, the pattern 220 of the sensing section 300 is still in the electrically conductive state even when the corrosion of the metal of the via 221 progresses, and the generation of the hydrogen sulfide may be undetectable. It is thus important to secure the creepage distance between the two vias 221.

As illustrated in the first example, when the creepage distance between two vias 221 out of the four vias 221 is set to be larger than the diameter w of each via 221, it is possible to sufficiently secure the creepage distance between the two vias 221. As a result, it is possible to prevent a situation in which the two vias 221 are short circuited and thus the hydrogen sulfide cannot be detected. Even when the pattern 220 includes vias 221 in a number larger than four, the vias 221 can be similarly disposed to sufficiently secure the creepage distance. In the case of generalization to a case where the pattern 220 includes N vias 221, it is only required to set a creepage distance dᵢⱼ between a first via 221-i (i=1, . . . , N) and a second via 221-j (j=1, . . . , N, i≠j) to be larger than each of a diameter wᵢ of the first via 221-i and a diameter wⱼ of the second via 221-j.

Further, the total amount of sulfide seeping out from the via 221 depends on the total amount of metal used in the via 221. Accordingly, the creepage distance between the two vias 221 can also be decided from simulation or actual experiment results. As an example, the creepage distance can be set to 5 mm or more.

### 3.2 Second Example

Part (B) in FIG. 5 is a schematic view illustrating a second example of the disposition of the vias 221. Part (B) in FIG. 5 is, similarly to part (A), a top view of the sensing section 300 as viewed from the first surface side. Further, similarly to part (A), the broken line indicates the pattern 220 that crosses the layer to reach the second surface through the via 221. In the second example, the four vias 221 (221-1, 221-2, 221-3, 221-4) are disposed on a straight line. In the second example as well, in order to sufficiently secure the creepage distance, the four vias 221 are disposed such that the creepage distance between the two vias 221 out of the four vias 221 is larger than the diameter w of each via 221. Specifically, the creepage distances d12, d23, d34 are each larger than w.

FIG. 5 merely illustrates examples of the disposition of the vias 221, and other patterns can be adopted for the disposition of the vias 221.

### 4 Effects

As described above, the hydrogen sulfide detection device 10 according to the present embodiment can detect generation of hydrogen sulfide from the battery cell. In particular, with the hydrogen sulfide detection device 10, the hydrogen sulfide gas passes through the recessed portion 201 in the first surface of the substrate 200 to flow into the via 221, and the metal of the via 221 corrodes. Thus, the generation of the hydrogen sulfide is detected. The hydrogen sulfide that has flowed in is brought to a state of staying inside of the via 221, and hence the corrosion of the metal of the via 221 progresses quickly even when only a minute amount of hydrogen sulfide flows in. As described above, the hydrogen sulfide detection device 10 according to the present embodiment can detect the generation of the hydrogen sulfide with high accuracy. Further, the hydrogen sulfide detection device 10 can be configured by diverting an existing substrate used for voltage monitoring of the battery cell or the like. Thus, the hydrogen sulfide detection device 10 can be configured with low cost.

Further, according to the present embodiment, the substrate 200 is disposed such that the first surface faces vertically upward. That is, the recessed portion 201 opens vertically upward. Hydrogen sulfide is heavier than air, and thus hydrogen sulfide more easily stays inside of the via 221. As a result, the detection accuracy of the hydrogen sulfide detection device 10 can be further improved.

Further, according to the present embodiment, the reinforcing plate 250 is attached to the second surface of the substrate 200 in the sensing section 300 in a part in which the pattern 220 is formed. In this manner, the resistance of the sensing section 300 against vibration and impact can be improved. Moreover, the reinforcing plate 250 may be fixed to the battery cell, an end plate, or the like. In this manner, a physical damage to be caused by vibration and impact can be reduced.

Further, in the present embodiment, the plating of the inner wall surface of the via 221 can be moderately reduced in thickness to accelerate the progress of the corrosion of the metal of the via 221. As a result, the detection accuracy of the hydrogen sulfide detection device 10 can be further improved.

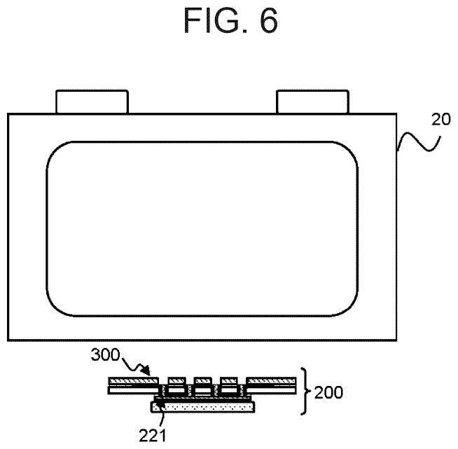

Moreover, in order to quickly detect the hydrogen sulfide generated from the battery cell, the substrate 200 of the hydrogen sulfide detection device 10 may be disposed such that the via 221 is positioned to face the battery cell. FIG. 6 is a schematic view illustrating an example of disposition of the substrate 200 of the hydrogen sulfide detection device 10. FIG. 6 schematically illustrates a battery cell 20. In the example illustrated in FIG. 6, the substrate 200 is disposed such that the via 221 is positioned to face the battery cell 20. When the via 221 is positioned to face the battery cell 20 as described above, the hydrogen sulfide easily flows into the via 221. As a result, the detection accuracy of the hydrogen sulfide detection device 10 can be further improved. Further, the hydrogen sulfide gas is heavier than air, and hence, when the substrate 200 is disposed below the battery pack, the detection accuracy can be further improved. Further, in order to detect generation of hydrogen sulfide at a plurality of portions in the battery pack, it is also effective to dispose substrates 200 at a plurality of portions in the battery pack.

What is claimed is:

1. A hydrogen sulfide detection device to be applied to a battery pack that stores a battery cell including a sulfide-based electrolyte, the hydrogen sulfide detection device comprising:
a wire that electrically connects a first node and a second node; and
a monitoring circuit that monitors a voltage between the first node and the second node, wherein:
the wire includes a pattern that is provided on a substrate and is made of a metal that reacts with hydrogen sulfide to corrode;
the pattern includes at least one via;
a recessed portion is present in a surface of the substrate; and
each of the at least one via is exposed to outside of the substrate through the recessed portion.

2. The hydrogen sulfide detection device according to claim 1, wherein:
the at least one via includes a first via and a second via that are spaced apart from each other; and
a creepage distance between the first via and the second via is larger than each of a diameter of the first via and a diameter of the second via.

3. The hydrogen sulfide detection device according to claim 1, wherein the at least one via is positioned to face the battery cell.

4. The hydrogen sulfide detection device according to claim 1, wherein the recessed portion opens vertically upward.

5. The hydrogen sulfide detection device according to claim 1, wherein the monitoring circuit determines whether or not hydrogen sulfide is generated from the battery cell based on a change of the voltage.
